(19) United States
(12) Patent Application Publication
(10) Pub. No.: US 2016/0071224 A1
(43) Pub. Date: Mar. 10, 2016

(54) Smart Table Service

(71) Applicant: Xin Huang, Redmond, WA (US)

(72) Inventor: Xin Huang, Redmond, WA (US)

(21) Appl. No.: 14/480,530

(22) Filed: Sep. 8, 2014

(51) Int. Cl. G06Q 50/12; G06Q 20/10; G06Q 20/32

(52) U.S. Cl. CPC G06Q 50/12; G06Q 20/3276; G06Q 20/102

(57) ABSTRACT

The instant application discloses, among other things, a Smart Table Service. In one embodiment, it may include ways for any entity, such as a restaurant, for example, to provide services to patrons, who may use their own devices. For instance, a restaurant may provide a linear barcode or quick response (QR) barcode, or other machine-readable symbol associated with a table, bar seat, or other location where a patron may wish to order, pay, call wait staff, or request other services. A patron at a location may scan a provided code using any device such as a smartphone, smartwatch, or intelligent eyewear, for example, and a server may receive a message indicating the location. In response to the location, the server may provide a web site or communicate with an app on the patron's device, allowing the patron to perform an action, such as ordering or paying.

### FIELD

This disclosure relates generally to a Smart Table Service.

### BACKGROUND

As people's daily lives become more hectic, many people, hoping to save time and energy, rely on establishments, such as restaurants, for goods and services. Unfortunately, many patrons still endure burdensome wait times at such establishments. For example, patrons must often wait for unreasonable periods of time to simply gain the attention of a server upon their arrival. Moreover, although some businesses, such as restaurants, may have begun using devices to take orders or facilitate staff communications, patrons often must still wait for overburdened servers to drop off a bill, for a credit card to be scanned, and for the final receipt to be delivered. Some establishments may provide devices which allow a patron to pay at their table without assistance, but for many restaurants, such devices are overly expensive and difficult to use.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a Smart Table Service, which may include ways for any entity, such as a restaurant, for example, to provide services to patrons, who may use their own devices. For instance, a restaurant may provide a linear barcode or quick response (QR) code, or other machine-readable symbol associated with a table, bar seat, or other location where a patron may wish to order, pay, call wait staff, or request other services. A patron at a location may scan a provided code using any device such as a smartphone, smartwatch, or intelligent eyewear, for example, and a server may receive a message indicating the location. In response to the location, the server may provide a web site or communicate with an app on the smartphone, allowing the patron to perform an action, such as ordering or paying. This may improve service for the patron, and improve efficiency for the restaurant, allowing, for example, wait staff to know when the patron is ready for a service. Additionally, it may reduce the number of visits required to a table. For example, a patron paying at a table may eliminate the need for wait staff to deliver an order confirmation (or bill), return to pick up a credit card, and return the credit card after processing it. This may also improve security for the patron, since the credit card may not leave the patron's possession.

### BRIEF DESCRIPTION OF THE DRAWINGS

FIG. 1 is a flow diagram illustrating a Smart Table Service process according to one embodiment.

FIG. 2 illustrates a user interface layout for a device application using a Smart Table Service, according to one embodiment.

FIG. 3 is illustrates a system capable of supporting a Smart Table Service, according to one embodiment.

FIG. 4 is a component diagram of a computing device to which a Smart Table Service process may be applied according to one embodiment.

### DETAILED DESCRIPTION

Many of the attendant features may be more readily appreciated as they become better understood by reference to the following detailed description considered in connection with the attached drawings, in which like parts are assigned like numerals.

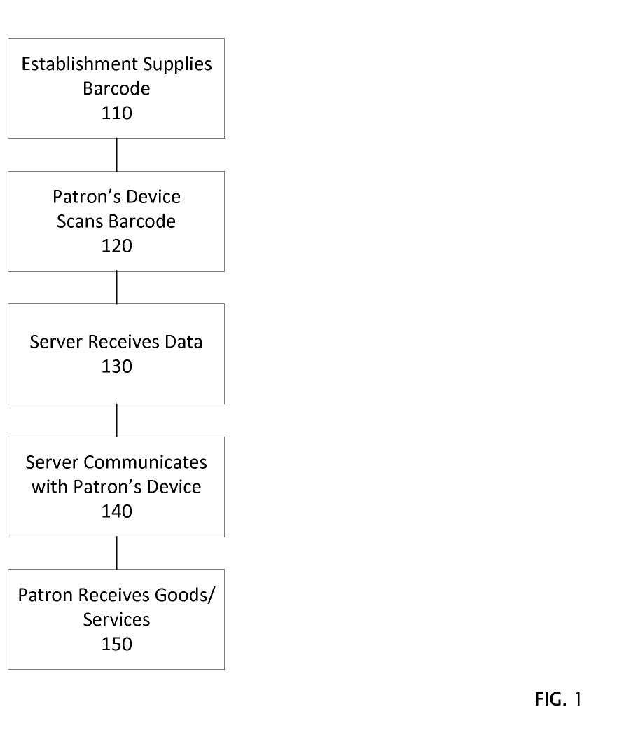

FIG. 1 is a flow diagram illustrating a Smart Table Service process according to one embodiment. At Establishment Supplies Barcode 110, a restaurant, for example, may display any machine-readable representation of data such as a linear barcode, quick response (QR) barcode, or matrix barcode, for example, associated with a restaurant table, bar seat, or any other object or location where a patron may wish to request services. In a second embodiment, a restaurant or other establishment may provide a URL for a patron to enter. At Patron Device Scans Barcode 120, a patron at a location may scan the provided code using any device such as a smartphone, a smartwatch or intelligent eyewear, for instance. In the second embodiment, a patron may enter a URL to access Smart Table Service. At Server Receives Data 130, a server may then receive a message indicating the patron's location. At Server Communicates with Patron Device 140, in response to the location, the server may provide a web site or communicate with an app on the patron's device, allowing the patron to perform an action, such as ordering, paying, or requesting other goods or services. At Patron Receives Goods/Services 150, the restaurant or third party may deliver the requested goods or services to the patron.

Smart Table Service may apply in any commercial or non-commercial context. For example, in another embodiment, it may be used by bidders at an auction by allowing them to use any device to scan a barcode affiliated with a particular auction item, and communicate their bid to the hosting entity or auctioneer. In yet another embodiment, it may be used at a social event, such as a wedding, to allow guests to check-in or request seating, for example.

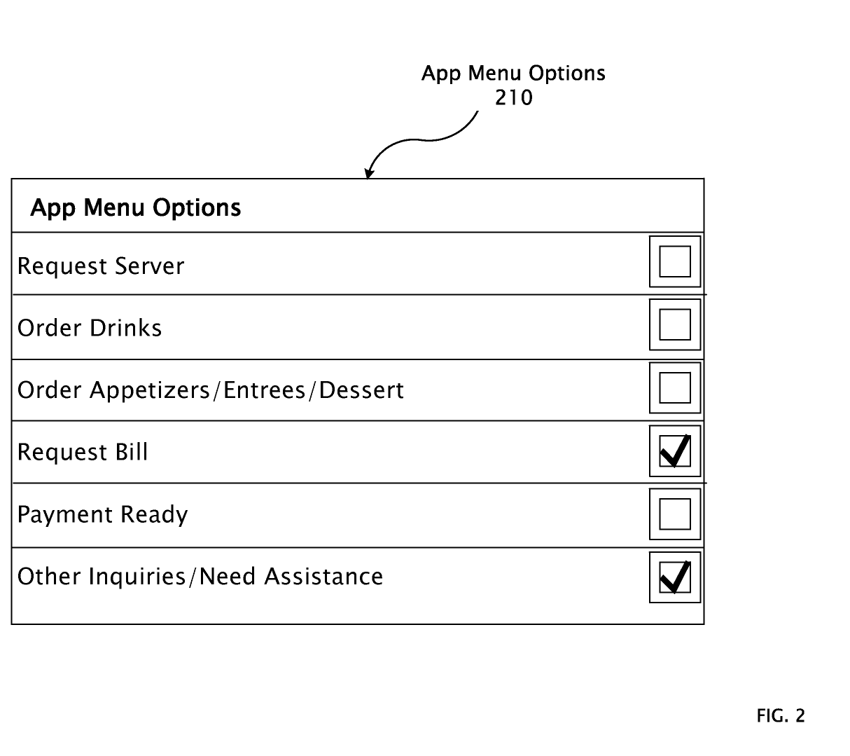

FIG. 2 illustrates a user interface layout for a device application using a Smart Table Service, according to one embodiment. In this example, App Menu Options 210 may display a drop-down menu of action items which a patron may select on her device. For example, in the restaurant context, a patron may select Request Bill to summon a server to her table with the bill, and she may also select the Other Inquiries/Need Assistance option to ask questions about amounts displayed on the bill, for instance. App Menu Options 210 may have various components and configurations, and it may be available in any language and any commercial or non-commercial context. For instance, the Smart Table Service commands may allow a person, for example, to submit a song request to a disc jockey at a dance club or karaoke bar, facilitate coat check at a fundraising event, or allow voters to cast selections on a ballot.

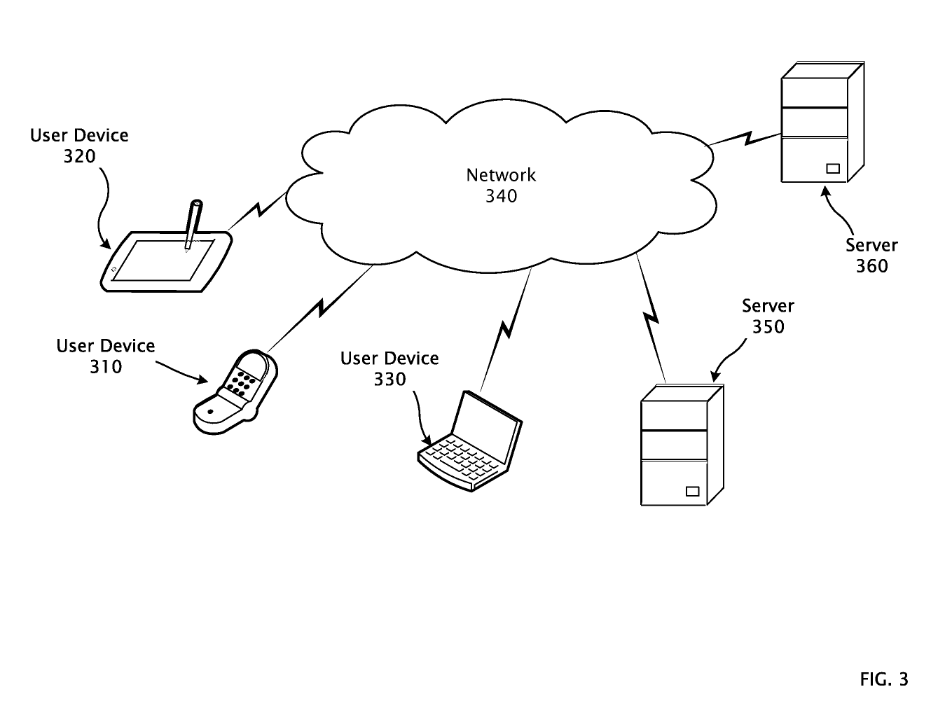

FIG. 3 is a block diagram illustrating an example of a system capable of supporting a Smart Table Service, according to one embodiment. Network 340 may include Wi-Fi, cellular data access methods, such as 3G or 4GLTE, Bluetooth, Near Field Communications (NFC), the internet, local area networks, wide area networks, or any combination of these or other means of providing data transfer capabilities. In one embodiment, Network 340 may comprise Ethernet connectivity. In another embodiment, Network 340 may comprise fiber optic connections.

User Device 310, 320, or 330 may be a smartphone, tablet, laptop computer, smartwatch or intelligent eyewear, or other device, and may have location-based services, for example GPS, cellphone tower triangulation capability, or accelerometers, and may have network capabilities to communicate with Server 350. Server 350 may include one or more computers, and may serve a number of roles. Server 350 may be conventionally constructed, or may be of a special purpose design for processing data obtained from a Smart Table Service. One skilled in the art will recognize that Server 350 may be of many different designs and may have different capabilities. Server 360 may include one or more computers, and may serve a number of roles. Server 360 may be conventionally constructed, or may be of a special purpose design for processing data obtained from a Smart Table Service. One skilled in the art will recognize that Server 360 may be of many different designs and may have different capabilities.

User Device 310, 320, or 330 may include device application to support Smart Table Service, for example allowing a user to request an action such as order food, or to pay a bill. In another embodiment, Device 310, 320, or 330 may display a web site hosted on Server 350 in a browser, which may allow a user to request an action.

In one embodiment, Server 350 may be operated by a party other than a user or an establishment offering Smart Table Service. Server 350 may then communicate with Server 360, which may be operated by the establishment, allowing a worker to receive a notification of the requested action.

In another embodiment, Server 350 may be operated directly by an establishment offering Smart Table Service. In this embodiment, a user using User Device 310, 320, or 330 may request an action. User Device 310, 320, or 330 may communicate with Server 350 via Network 340, and Server 350 may notify a worker of the request.

An establishment may also provide a User Device 310, 320, or 330 to a patron to provide access to Smart Table Service.

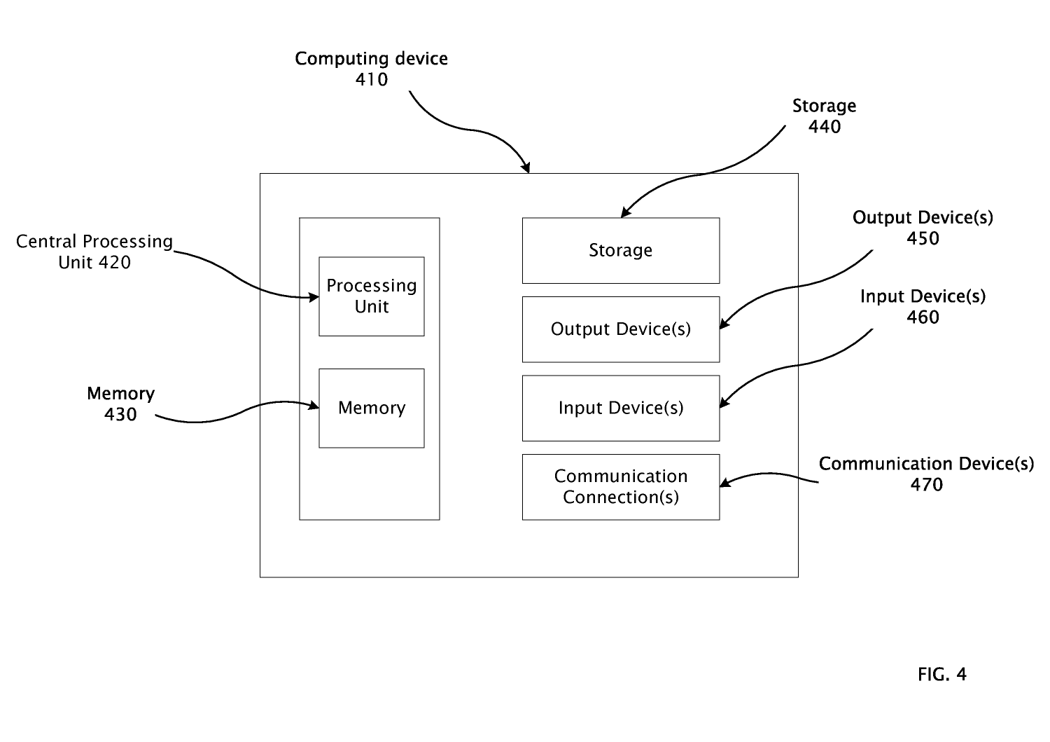

FIG. 4 is a component diagram of a computing device to which a Smart Table Service process may be applied according to one embodiment. The Computing Device 410 can be utilized to implement one or more computing devices, computer processes, or software modules described herein, including, for example, but not limited to a mobile device. In one example, the Computing Device 410 can be used to process calculations, execute instructions, and receive and transmit digital signals. In another example, the Computing Device 410 can be utilized to process calculations, execute instructions, receive and transmit digital signals, receive and transmit search queries and hypertext, and compile computer code suitable for a mobile device. The Computing Device 410 can be any general or special purpose computer now known or to become known capable of performing the steps and/or performing the functions described herein, either in software, hardware, firmware, or a combination thereof.

In its most basic configuration, Computing Device 410 typically includes at least one Central Processing Unit (CPU) 420 and Memory 430. Depending on the exact configuration and type of Computing Device 410, Memory 430 may be volatile (such as RAM), non-volatile (such as ROM, flash memory, etc.) or some combination of the two. Additionally, Computing Device 410 may also have additional features/functionality. For example, Computing Device 410 may include multiple CPU's. The described methods may be executed in any manner by any processing unit in computing device 410. For example, the described process may be executed by both multiple CPU's in parallel.

Computing Device 410 may also include additional storage (removable and/or non-removable) including, but not limited to, magnetic or optical disks or tape. Such additional storage is illustrated in FIG. 4 by Storage 440. Computer readable storage media includes volatile and nonvolatile, removable and non-removable media implemented in any method or technology for storage of information such as computer readable instructions, data structures, program modules or other data. Memory 430 and Storage 440 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 410. Any such computer readable storage media may be part of computing device 410. But computer readable storage media does not include transient signals.

Computing Device 410 may also contain Communications Device(s) 470 that allow the device to communicate with other devices. Communications Device(s) 470 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer readable storage media and communication media. The described methods may be encoded in any computer-readable media in any form, such as data, computer-executable instructions, and the like.

Computing Device 410 may also have Input Device(s) 460 such as keyboard, mouse, pen, voice input device, touch input device, etc. Output Device(s) 450 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A Smart Table Service method, comprising:
receiving, at a server, data obtained from a scan of a machine-readable representation of data, the data representing a location of a user within an establishment;
receiving, at the server, data representing an action desired by the user;
sending, from the server, a notification indicating the desired action and location; and
performing the desired action in response to the notification.

2. The method of claim 1, wherein the machine-readable representation of data comprises a barcode.

3. The method of claim 1, wherein the notification is sent to a device from the group containing a smartphone, tablet, laptop computer, smartwatch or intelligent eyewear.

4. The method of claim 1, wherein the desired action is placing an order for food or drinks.

5. A system, comprising:
a server, comprising:
a processor;
a memory coupled to the processor;
components operable on the processor, comprising:
a data receiving component, configured to receive a request for goods or services;
a location receiving component, configured to receive a location of a source of the request, the location indicating a particular table or seat for a patron of a bar or restaurant;
a notification component, configured to send a notification to a user device, the notification comprising the location and the request.

6. A computer-readable storage media containing instructions thereon which, when executed, perform a method comprising:
receiving, at a server, data obtained from a scan of a machine-readable representation of data, the data representing a location of a user within an establishment;
receiving, at the server, data representing an action desired by the user;
sending, from the server, a notification indicating the desired action and location.

7. The method of claim 5, further comprising performing the desired action.

8. The method of claim 6, wherein the desired action is paying a bill using a credit card.
